(19) United States
(12) Patent Application Publication
(10) Pub. No.: US 2002/0040452 A1
(43) Pub. Date: Apr. 4, 2002

(54) Method for producing a connection redundancy for a serial communication system having a master unit and a plurality of slave units, which are interconnected as a concatenation of point-to-point connections in line topology, and corresponding serial communication system

(76) Inventors: Gunther Birk, Erlangen (DE); Markus Gross, Fuerth (DE); Ulrich Hahn, Fuerth (DE); Peter Jaenicke, Erlangen (DE); Martin Teckentrup, Zirndorf (DE)

Correspondence Address: BAKER & BOTTS, 30 ROCKEFELLER PLAZA, NEW YORK, NY, 10112

(21) Appl. No.: 09/918,593

(22) Filed: Jul. 31, 2001

(30) Foreign Application Priority Data
Sep. 27, 2000 (DE) 100 479 23.5

(51) Int. Cl. H04B 1/74

(52) U.S. Cl. 714/43

(57) ABSTRACT

In a serial communication systems embodied as mono-master system in line topology, the invention achieves tolerance with respect to an arbitrary fault by using an additional return line to the master. This connection serves only for monitoring purposes during normal operation and it is only activated in the event of a line interruption, in order to undertake the communication to the “isolated” subscribers. In this case, two independent lines exist from the master to the slaves.

### FIELD OF INVENTION

The invention relates to a method for producing a redundant connection for a serial communication system having a master unit and a plurality of slave units, which are interconnected as a concatenation of point-to-point connections in line topology, and further to a serial communication system having a master unit and a plurality of slave units, which are interconnected as a concatenation of point-to-point connections in line topology.

### BACKGROUND OF THE INVENTION

Serial communication systems are sensitive to interruptions of the transmission medium since communication to the subscribers downstream of the interruption is rendered impossible. This is true even of serial communication systems which communicate via a bus system. Such a communication system having a plurality of communication subscribers TL1 to TLn is shown in FIG. 1a. Each of these communication subscribers TL1 to TLn is connected to the communication network, the bus system B, via a special line driver or a communication interface Kom E1. If an interruption occurs in the bus system, then the communication subscribers situated downstream of the interruption are cut off from the communication, since they can no longer receive data from the communication subscribers situated upstream of the interruption location, or transmit data to said communication subscribers. It is only when the interruption is situated between the bus system and the communication electronics Kom_E1 of a subscriber that only this subscriber is cut off from the communication.

The susceptibility to disturbances is drastically increased, however, if the communication link is effected not as bus B but as a concatenation of point-to-point connections in a line topology. Such a serial communication system having a line topology is shown in FIG.1b. As shown, the communication subscribers TL1 to TLn are connected to one another via line connections L1 to L(n−1) respectively arranged between the communication electronics Kom_E1 of adjacent subscribers. The number of lines required is the number of communication subscribers minus one. The numerous plug connections as well as the communication electronics Kom_E1 required in each subscriber TL1 to TLn constitute possible fault sources. Furthermore, in such arrangements having a concatenation of point-to-point connections in line topology, it is not possible to exchange individual subscribers TL1 to TLn without interrupting the communications. The risk of a communication interruption due to line damage or faulty plug connections is conventionally minimized through the use of doubled, i.e. redundant, cabling. Such a procedure according to the prior art is shown in FIG. 2a, where not only a first bus system B1, but also a second bus system B2 is provided, wherein B2 is likewise connected to all the communication subscribers. This results in an additional outlay since each communication subscriber requires two separate communication electronics Kom_E1, i.e., one for each bus system B1 and B2.

A further problem is that, in the case of interlinked point-to-point connections (line topology), it is only possible to exchange individual subscribers when the communication electronics can be isolated independently of the subscribers, i.e. mechanically, and equipped with a separate power supply, e.g. via the “bus cable”. The conventional solution is illustrated in FIG. 2b. Nevertheless, the general problem of susceptibility to disturbance is not eliminated. The same problem arises also in a mono-master communication system with interlinked point-to-point connections (line topology), in which the communication subscribers comprise a master unit and a plurality of slave units.

It is an object of the present invention to ensure, in a serial communication system with interlinked point-to-point connections, even when a line interruption occurs, a reliable communication without doubled cabling between all the communication subscribers.

### SUMMARY OF THE INVENTION

According to the present invention, a serial communication system, having a master unit and a plurality of slave units, are interconnected as a concatenation of point-to-point connections in line topology, wherein an additional connection is made between the two line termination subscribers, e.g., from the slave unit which is furthest away from the master unit in the line to the master unit, and which, in the event of a line interruption in the line topology serves for undertaking the communication to the isolated slave units.

It has been found to be preferred if the additional connection can only be activated in the event of a line interruption in the line topology; and that the additional connection may serve for monitoring purposes during normal operation.

In a further preferred embodiment, a detector is provided for detecting a line interruption, as well as a sporadic interruption, in the line topology, by which the communication between the master unit and the isolated slave units can be activated via the additional connection to the master unit. The detection means is particularly advantageously arranged in the master unit.

If a synchronous data transfer takes place on the communication line by means of cyclic telegrams exchanged in the transmission cycle, then it has been found to be preferred if each slave unit is provided, for each data direction, with a counter for determining the valid telegrams transmitted in the last transmission cycle, in which case a respective counter reading of a slave unit can be communicated from the latter as part of a telegram, sent to the master unit per transmission cycle, to the master unit, in which a line interruption can be localized using the counter readings of all the slave units.

In order to achieve identification of a failure of a number of cyclic telegrams, sent from the master unit to the slave units, on account of a line interruption, it is preferred that a line interruption in the master unit be localized using the counter readings reported by the slave units which, from the point of view of the master unit, are situated downstream of the disturbed location in the line topology.

If the present invention is to achieve identification of a failure on account of a line interruption of a number of cyclic telegram which have been sent from the slave units to the master unit, line interruption is localized in the master unit using the counter readings reported by the slave units which, from the point of view of the master unit are situated upstream of the disturbed location in the line topology.

According to a further preferred embodiment of the invention, the detection means in the master unit is embodied as a suitably programmed microprocessor.

The object of the present invention may also be achieved by means of a method for producing a redundant connection for a serial communication system having a master unit and a plurality of slave units, which are interconnected as a concatenation of point-to-point connections in line topology, by means of the following method steps:

providing an additional connection between the two line terminating subscribers, in particular from the slave unit which is furthest away from the master unit in the line to the master unit; and

undertaking the communication to the isolated slave units in the event of a line interruption in the line topology.

According to yet another preferred embodiment of the present invention, the following further method steps have been found to produce favorable results:

activating the communication to the isolated slave units via the additional connection, in the event of a line interruption in the line topology; and

informing the isolated slave units via the additional connection that the master unit can only be reached via the additional connection.

If an intermittent line interruption occurs, the following further method steps will be implemented in accordance with the present invention:

localization of the interruption location; and

production of a permanent interruption by communication to the last slave unit upstream of the interruption location for establishing the transmission of telegrams.

If a synchronous data transfer takes place on the communication line by means of cyclic telegrams exchanged in the transmission cycle, then localization of a line interruption can be achieved according to the invention by means of the following further method steps:

determination of the valid telegrams transmitted in the last transmission cycle for each slave unit for each data direction;

communication of the respective determined number of a slave unit as part of a telegram, sent to the master unit per transmission cycle, to the master unit; and

localization of a line interruption using the reported numerical values of all the slave units.

In order to identify a failure of a number of cyclic telegrams sent from the master unit to the slave units, on account of a line interruption, the following further method step has proved to be advantageous:

localization of the line interruption in the master unit using the numerical values reported by the slave units which, from the point of view of the master unit, are situated downstream of the disturbed location in the line topology.

By contrast, if the intention is to achieve identification of a failure of a number of cyclic telegrams, which have been sent from the slave units to the master unit, on account of a line interruption, then the following further method step is recommended:

localization of the line interruption in the master unit using the numerical values reported by the slave units which, from the point of view of the master unit, are situated upstream of the disturbed location in the line topology.

For serial communication systems in a mono-master system in line topology, the present invention achieves tolerance with respect to an arbitrary fault by using an additional return line to the master. This connection serves only for monitoring purposes during normal operation and is only activated in the event of a line interruption, in order to undertake the communication to the “isolated” subscribers. In this case, two independent lines exist from the master to the slaves.

### DRAWINGS

Further advantages and details regarding the present invention are described below in the context of an exemplary embodiment shown in the drawings in which elements having the same functionality are denoted by the same reference symbols and in which:

FIG. 1a shows a serial communication system in line topology with a bus system;

FIG. 1b shows a serial communication system in line topology with a concatenation of point-to-point connections;

FIG. 2a shows a serial communication system according to FIG. 1a with a second bus system according to the prior art;

FIG. 2b shows a serial communication system according to FIG. 1b with communication electronics independent of the subscriber;

FIG. 3 shows a serial communication system according to the present invention with a return line during normal operation;

FIG. 4 shows a serial communication system according to the present invention with a return line after a line interruption;

FIG. 5 shows a number of cyclic telegrams during normal operation for a serial communication system according to the present invention with a return line; and

FIG. 6 shows a number of cyclic telegrams in the event of a temporary line disturbance for a serial communication system according to the present invention with a return line.

### DETAILED DESCRIPTION OF THE INVENTION

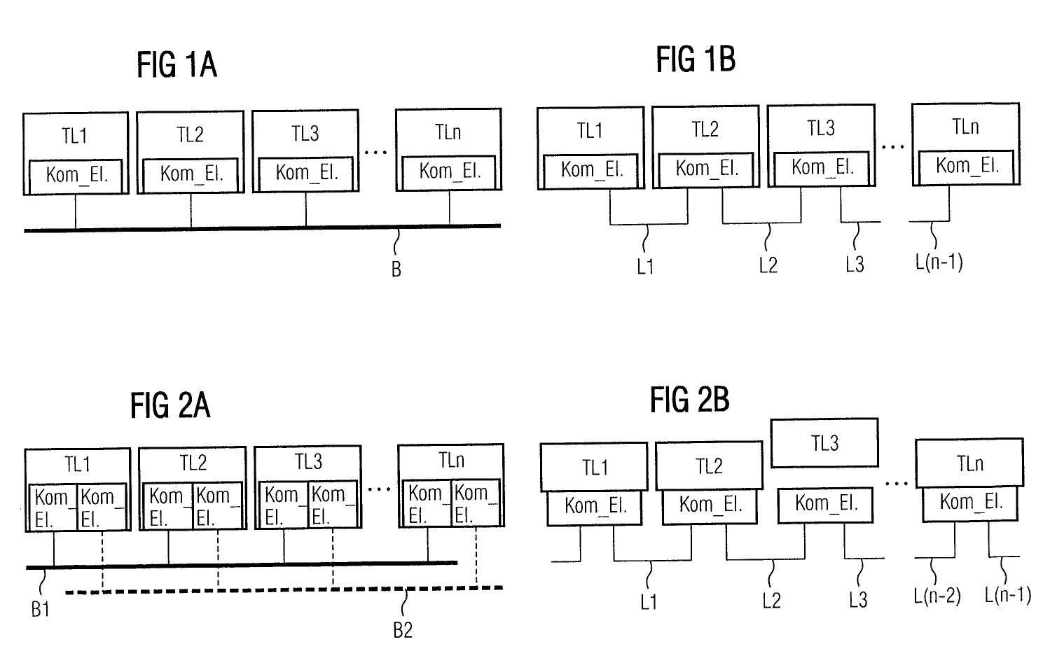

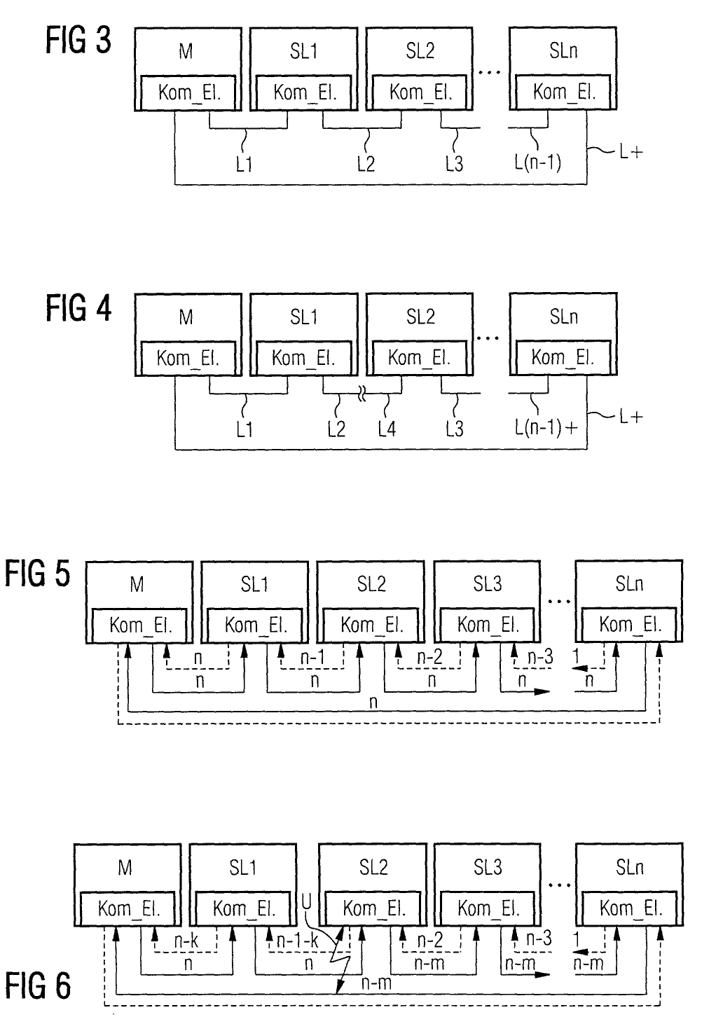

FIGS. 1a, 1b and 2a, 2b represent the prior art and have already been described above in detail. FIG. 3 shows a serial communication system according to the present invention with a return line during normal operation. The structure of the communication network essentially corresponds to that according to FIG. 1b, i.e., to a serial communication system in line topology with communication subscribers connected as a concatenation of point-to-point connections.

A mono-master network is shown as master unit M, generally arranged at one line end, and a plurality of slave units SL1 to SLn. The master unit is connected to the first slave unit SL1 by cable connection L1. The slave unit SL1 is connected to the second slave unit SL2 via cable L2 and this continues up to the last slave unit SLn via cable L(n−1). Each cable can contain two lines for a bidirectional full-duplex connection with desired values being transmitted from the master unit M to the slave units SL1 to SLn and the slave units SL1 to SLn supplying respective actual values in the direction of the master unit M. In this case, the communication between the individual subscribers is effected in particular with the aid of telegrams T which are exchanged via the communication network. A return line L+ is led from the last slave unit SLn back to the master unit M. If the master unit M is not arranged at a line end, then the return line L+ is implemented between the two slave units constituting the line terminating subscribers. The resulting ring topology is identical in both cases; however, the traditional topology, with the master unit M at one line end, is assumed below.

FIG. 4 shows a serial communication system according to the present invention with a return line, as described in FIG. 3, after a line interruption U. In this case, the line interruption U occurs, for example, between the slave units SL2 and SL3. Accordingly, the line L2 is interrupted. In order to maintain communication between all the subscribers M, SL1 . . . SLn, the return line L+ is activated. From the point of view of the master unit M, communication is now effected via two lines, in the first place via the previous line topology with line L1 to the slave unit SL1 and, further via the return line L+ as second communication line. The second communication line also makes it possible to reach all the slave units which are arranged downstream of the line interruption U via the cables or lines L(n−1)+ to L3+ which are assigned to the second line L+. The latter relationship is illustrated by the fact that these lines are now likewise denoted with a “+”.

The main advantage of the present invention resides in the minimal hardware outlay required, since only a single cable L+ is additionally necessary in order to overcome all the difficulties mentioned above. The remaining functionality is provided in the region of the communication electronics of the slaves, or in the software of the master. This is described in more detail below. By adding a return line to the master unit M, mono-master systems in line topology according to FIG. 3 and FIG. 4 can be made absolutely tolerant with respect to line interruptions U. The novel method enables reliable and fast detection of an interruption U, even if the latter only occurs sporadically and fast activation of the return line L+.

The sequence when a disturbance occurs can be seen as follows:

1. localization of the possibly sporadic disturbance U;

2. production of a permanent interruption in order to ensure the independence of the two communication lines; (to this end, the master sends to the last subscriber upstream of the disturbed connection, in this case the slave unit SL1, the command for establishing the transmission of telegrams); and

3. activation of the second communication line L+, L(n−1)+, . . . L3+; (to this end, the isolated subscribers are informed that the master unit M can now only be reached via the second line with the return line L+. Accordingly, the data traffic can be taken up on the second line).

After the elimination of the disturbance U, normal operation can be resumed as follows:

1. notification of the subscribers on the second communication line L+, L(n−1)+. . . L3+ that the communication is switched over again to the original first communication line L1 . . . L(n−1);

2. Eliminate interruption U; (to this end, a command from the master unit M is issued to the last subscriber upstream of the formerly disturbed connection, in this case to the slave unit SL1, for resuming the transmission of telegrams T); and

3. reactivate a possibly implemented monitoring function via the return line L+.

This method will now be explained in a clock-synchronous communication. An essential requirement of the application in this case is that fewer than two bus cycles are permitted to elapse between the occurrence of a (possibly sporadic) line disturbance U and the activation of the second communication line, i.e. the undisturbed continuation of the communication to all the subscribers.

A difficult task is reliable localization of an only sporadic disturbance U which, under certain circumstances, results merely in the loss of a single telegram T. The solution for this, according to the present invention, is to equip each of the slave units with two counters in order to determine, separately for both data directions of the full-duplex connection, the number of valid cyclic telegrams transmitted in the last transmission cycle. The telegrams that are in any case sent once per transmission cycle from the slave units SL1 to SLn to the master unit M are extended by the counter readings in the case of the redundancy option described. The task of a control for the master unit M, e.g. in the form of a software, is to determine the disturbed connection from the counter readings of all the slave units SL1 to SLn. The solution to this problem is essentially based on the insight that all the slave units SL1 to SLn must transmit the same number n of telegrams in the “desired value direction”, while in the “actual value direction”, the number of telegrams to be transmitted in each case increases by one from slave unit to slave unit in the direction of the master unit M. This relationship is shown in FIG. 5 by each cable L1 to L(n−1) and L+ comprising two lines. One serves for communication in the “desired value direction” (solid line), and the other line serves for communication in the “actual value direction” (broken line).

In a manner corresponding to the number of slave units SL present, the number of n telegrams are sent from the master unit M in the “desired value direction” to the slave units SL1 to SLn. Each slave unit SL1 to SLn must transmit each of these n telegrams. The situation is different in the “actual value direction”, where each slave unit sends a telegram to the master unit M. Whereas the slave unit SLn which is furthest away from the master unit M does not have to transmit a telegram, the last slave unit SL1 as seen in the “actual value direction” must transmit the telegrams of the “previously” situated slave units SL2 to SLn, that is to say n−1 telegrams.

By way of example, if a sporadic interruption U of a line m causes failure of cyclic telegrams from the master unit M in the desired value direction between the first slave unit SL1 and the second slave unit SL2, all the subscribers SL2 to SLn situated downstream of the disturbed location U report, in the next cycle, correspondingly fewer telegrams (n-n) transmitted in the desired value direction. This relationship is illustrated in FIG. 6, which shows the number of cyclic telegrams in the event of a temporary line disturbance between the first slave unit SL1 and the second slave unit SL2 for a serial communication system according to the invention with a return line L+.

If the disturbance concerns the actual value direction with the failure of k of the telegrams sent from the slave units SL2 to SLn to the master unit M, then this can be determined from the telegram number reported by the subscribers—in this case slave unit SL1—upstream of the disturbed location U. The situation shown in FIG. 6 illustrates these relationships assuming that, at the disturbed location U, owing to a sporadic line interference, m cyclic telegrams fail in the desired value direction and k cyclic telegrams fail in the actual value direction.

1. A serial communication system comprising a master unit and a plurality of slave units which are interconnected as a concatenation of point-to-point connections in line topology, further comprising an additional connection between the master unit and the slave unit which is furthest away from the master unit in the line and which additional connection, in the event of an interruption in the line topology serves to communicate with the isolated slave units.

2. The system according to claim 1, wherein the additional connection can only be activated in the event of a line interruption in the line topology.

3. The system according to claim 1, wherein the additional connection serves for monitoring purposes during normal operation.

4. The system according to claim 1, further comprising a detector for detecting an interruption, in the line topology which activates the additional connection.

5. The system according to claim 4, wherein the detector is arranged in the master unit.

6. The system according to claim 1, wherein a synchronous data transfer takes place on the line topology by means of cyclic telegrams exchanged in a transmission cycle, and further comprising a counter provided in each slave unit for each data direction, for determining valid telegrams transmitted in a last transmission cycle, and wherein a respective counter reading of a slave unit can be communicated from the slave unit as part of a telegram sent to the master unit per transmission cycle, whereby a line interruption can be localized using the counter readings of all the slave units.

7. The system according to claim 6, in which a failure of a number of cyclic telegrams sent from the master unit to the slave units, said failure resulting from a line interruption, is identified, wherein a line interruption in the master unit can be localized using the counter readings reported by the slave units which are situated downstream of the disturbed location in the line topology.

8. The system according to claim 6 in which a failure of a number of cyclic telegrams which have been sent from the slave units to the master unit is identified, wherein the line interruption in the master unit can be localized using the counter readings reported by the slave units which are situated upstream of the disturbed location in the line topology.

9. The system according to claim 5, wherein the detector is embodied as a suitably programmed microprocessor.

10. A method for producing a connection redundancy for a serial communication system having a master unit and a plurality of slave units which are interconnected as a concatenation of point-to-point connections in line topology comprising providing an additional connection between the master unit and the slave unit which is furthest from the master unit in the line topology, said additional connection undertaking the communication with the isolated slave units in the event of a line interruption in the line topology.

11. The method according to claim 10, further comprising the steps of activation of the communication to the isolated slave units via the additional connection in the event of a line interruption in the line topology, and informing the isolated slave units via the additional connection that the master unit can only be reached via the additional connection.

12. The method according to claim 10, wherein the line interruption is intermittent and further method comprising localization of the interruption location and production of a permanent interruption by communication to the last slave unit upstream of the interruption location for establishing the transmission of telegrams.

13. The method according to claim 10, further comprising a synchronous data transfer taking place on the communication line by means of cyclic telegrams exchanged in the transmission cycle, wherein localizing a line interruption results from a determination of the valid telegrams transmitted in the last transmission cycle for each slave unit for each data direction; communication of the respective determined number of a slave unit as part of a telegram sent to the master unit per transmission cycle to the master unit; and localization of a line interruption using the reported numerical values of all the slave units.

14. The method according to claim 13, wherein identification of a failure of a number of cyclic telegrams sent from the master unit to the slave units results from localization of the line interruption in the master unit using the numerical values reported by the slave units which, are situated downstream of the disturbed location in the line topology.

15. The method according to claim 13, wherein identification of a failure of a number of cyclic telegrams, which have been sent from the slave units to the master unit result from localization of the line interruption in the master unit using the numerical values reported by the slave units which, are situated upstream of the disturbed location in the line topology.
